(19) United States
(12) Patent Application Publication
(10) Pub. No.: US 2015/0214812 A1
(43) Pub. Date: Jul. 30, 2015

(54) CONNECTOR PROTECTION STRUCTURE FOR MOTOR

(71) Applicant: TOYOTA JIDOSHA KABUSHIKI KAISHA, Toyota-shi Aichi-ken (JP)

(72) Inventors: Eiichi Tooyama, Nakatsugawa-shi Gifu-ken (JP); Yasuyuki Moriuchi, Toyota-shi Aichi-ken (JP); Michito Hirota, Toyota-shi Aichi-ken (JP)

(21) Appl. No.: 14/602,503

(22) Filed: Jan. 22, 2015

(30) Foreign Application Priority Data
Jan. 28, 2014 (JP) 2014-013075

(51) Int. Cl. H02K 5/22

(52) U.S. Cl. CPC H02K 5/225; H02K 2203/09

(57) ABSTRACT

A connector protection structure of motor includes a motor case that houses the motor, a connector that is placed on an outer surface of the motor case, and a protection member that is provided between the connector and a side member (LSM) of a vehicle, and that is fixed on the motor case. The protection member includes a protection section that is provided in a projected arrangement around the connector, a fixing section that is linked to the protection section and that is fixed by a bolt on a rear surface of the motor case, and a support section that is linked to the fixing section, that includes a through hole through which a stud, provided in a projected arrangement on a side surface of the motor case, penetrates, and that is supported on the side surface by the stud.

### PRIORITY INFORMATION

This application claims priority to Japanese Patent Application No. 2014-013075, filed on Jan. 28, 2014, which is incorporated herein by reference in its entirety.

### TECHNICAL FIELD

The present invention relates to a connector protection structure for a motor that protects a connector by preventing contact of a side member of a vehicle, which is deformed during collision of the vehicle, with the connector in a motor case.

### BACKGROUND ART

There are known vehicles such as an electric automobile that drives a vehicle with a motor and a hybrid electric automobile equipped with a motor and an engine. In these vehicles, in order to improve the traveling performance, an inverter and a high-voltage power cable that control electric power of a high-voltage battery and supply the electric power to the motor are provided. Thus, various considerations are being made with respect to a collision accident. In collisions of these vehicles, in the case of non-serious collisions, it is desirable that the inverter does not fail and disconnection of the power cable and damage to the connector do not occur. In vehicle collisions with a high impact, it is desirable that a high-voltage blocking function of the battery and a rapid electricity discharge function of the high voltage in the inverter normally operate, and electricity leakage due to disconnection of the power cable and the damaging of the connector do not occur.

In recent years, techniques for preventing damage to the connector during vehicle collision have been developed, in order to realize such functions. For example, JP 2013-66327 A discloses a connector protection structure of a motor in which a protection member that prevents contact of a side member and a connector due to deformation of the side member during the collision is fixed on the motor case by a bolt from two axial directions. According to the connector protection structure, because a metal protection member is bolt-fixed from two axial directions, the load applied to the connector by the folding deformation of the side member can be received and the connector can be protected.

In the motor connector protection structure described in JP 2013-66327 A, a fixing section of the protection member has, in an integrated manner, a first side wall and a second side wall that are approximately orthogonal to each other, and the first and second side walls of the fixing section are fixed by tightening the bolt from the two axial directions on a rear surface and a side surface of the motor case. In this case, it is difficult to fix the protection member such that both the first and second side walls of the protection member are seated on outer surfaces of the motor case, and there is a problem in that the assembly capability of the protection member is inferior.

More specifically, operations are required to provisionally tighten the first side wall of the fixing section with a bolt, then provisionally tighten the second side wall of the fixing section with a bolt, and finally tighten the bolts of the side walls to fix the protection member on the motor case, which results in an inferior assembly capability. Even if the protection member is fixed in this manner, due to manufacturing error of the components or the like, there may be cases where one of the first and second side walls is not seated on the outer surfaces of the motor case, in which case, the tightening force by the bolt becomes insufficient, and there is a risk that loosening of the bolt tends to occur.

An advantage of the present invention is that a connector protection structure of a motor is provided that has superior assembly capability to the motor case, that receives collision load with two side surfaces of the motor case, and in which the protection member is not detached during the collision so as to reliably prevent damage to the connector.

### SUMMARY OF THE INVENTION

According to one aspect of the present invention, there is provided a connector protection structure of a motor, comprising: a motor case that houses a motor; a connector that is placed on an outer surface of the motor case in an exposed manner and that is configured to supply electric power to the motor; and a protection member that is provided between the connector and a side member of a vehicle near the connector, and that is fixed on the motor case, wherein the protection member comprises: a protection section that is provided in a vertical arrangement around the connector; a fixing section that is linked to the protection section and that is fixed by a bolt on a first side surface of the motor case; and a support section that is linked to the fixing section, that has a through hole through which a stud, provided in a vertical arrangement on a second side surface of the motor case in an orientation different from the first side surface, penetrates, and that is supported on the second side surface by the stud.

According to another aspect of the present invention, preferably, in the connector protection structure of motor, a hook portion that inhibits deviation of the stud in an axial direction in the through hole due to an input of a collision load is formed on at least one of an outer circumferential surface of the stud and an inner circumferential surface of the through hole.

According to another aspect of the present invention, preferably, in the connector protection structure of motor, the hook portion is formed as a male screw thread formed on the outer circumferential surface of the stud or a female screw groove formed on the inner circumferential surface of the through hole.

According to another aspect of the present invention, preferably, in the connector protection structure of motor, the protection section of the protection member includes, in an integrated manner, a side protection section provided covering a side portion of the connector and an upper protection section provided covering an upper portion of the connector.

According to the connector protection structure of motor of various aspects of the present invention, the protection member can be fixed by provisionally placing the protection member on the second side surface of the motor case while penetrating the stud through the through hole of the support section and then tightening the fixing section with a bolt in a state where the fixing section is reliably seated on the first side surface of the motor case. Therefore, the assembly capability of the protection member on the motor case can be improved. In addition, by employing a structure in which the input collision load due to contact of a deformed side member on the protection member during collision is received at two side surfaces of the motor case, it becomes possible to prevent damage to the motor case and detachment of the protection member, and to consequently reliably protect the connector.

### BRIEF DESCRIPTION OF THE DRAWINGS

FIG. 1 is a perspective view showing a connector protection structure of a motor according to a preferred embodiment of the present invention.

FIG. 2 is a diagram showing a deformation state of a vehicle equipped with a connector protection structure of a motor according to a preferred embodiment of the present invention, viewed from above the vehicle.

FIG. 3A is a front view showing a protection member in a preferred embodiment of the present invention.

FIG. 3B is an upper view showing a protection member in a preferred embodiment of the present invention.

FIG. 3C is a side view showing a protection member in a preferred embodiment of the present invention.

FIG. 4 is a cross sectional diagram and a partial enlarged view showing a fitting structure between a through hole of the protection member and a stud provided in a projected arrangement on a motor case in a preferred embodiment of the present invention.

FIG. 5 is an explanatory diagram for explaining a contact state between a protection member and a side member in a preferred embodiment of the present invention.

FIG. 6A is a graph showing a stress generation state of a motor case in a preferred embodiment of the present invention during a collision of the vehicle.

FIG. 6B is a graph showing a stress generation state of a motor case in a Comparative Example during a collision of the vehicle.

### DETAILED DESCRIPTION OF THE EMBODIMENT

A preferred embodiment of the present invention will now be described in detail with reference to the accompanying drawings. In this description, the specific shape, material, numerical value, direction, etc. are provided merely as examples, to facilitate understanding of the present invention, and may be suitably changed according to the usage, objective, specification, etc. In addition, in the following description, when a plurality of embodiments and modified configurations are included, it is understood that the characteristics thereof may be suitably combined.

In the following description, an example configuration will be described in which the motor connector protection structure is applied to a hybrid electric vehicle equipped with a motor and an engine. However, the present invention is not limited to such a configuration, and may be applied to an electric automobile equipped only with the motor as a traveling motive power source. Moreover, a number of the motor generators to be equipped may be 1 or a plurality.

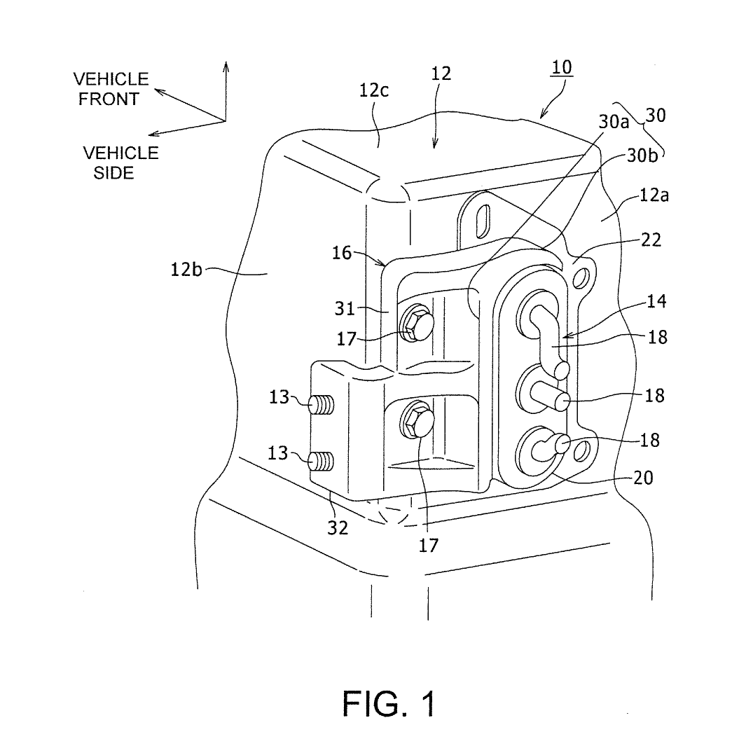

FIG. 1 is a perspective diagram showing a connector protection structure of a motor 10 (hereinafter also referred simply as “connector protection structure”) according to a preferred embodiment of the present invention. FIG. 1 is shown in a viewpoint from a diagonal rear direction of the vehicle.

The connector protection structure 10 comprises a motor case 12 that houses a motor (not shown), a connector 14 provided on an outer surface of the motor case 12 in an exposed manner, and a protection member 16 that is fixed on the motor case 12 and that protects the connector 14.

The motor case includes therein a power generator (generator MG1) that can generate electric power using the motive power of the engine, a motor (motor MG2) that can drive the vehicle, and a motive power distribution mechanism that distributes the engine power to the power generator or an axle, and is also known as a transaxle.

The motor case 12 may be formed, for example, from a die-cast component made of a metal such as an aluminum alloy. In the present embodiment, the motor case 12 comprises a rear surface (first side surface) 12a facing the rear side of the vehicle, a left side surface (second side surface) 12b facing a side of the vehicle, and an upper side surface 12c facing upward from the vehicle. These surfaces 12a, 12b, and 12c may be formed to be orthogonal to each other, or may be surfaces that are not orthogonal so long as the surfaces approximately face the rear side, the side, and the upward direction from the vehicle.

The connector 14 is a member for supplying electric power to the motor MG2 built in the motor case 12. The connector 14 comprises a power cable 18 which is an electric power conducting line, a connector body 20 made of an insulating resin, and a connector plate 22 fixed on the connector body 20.

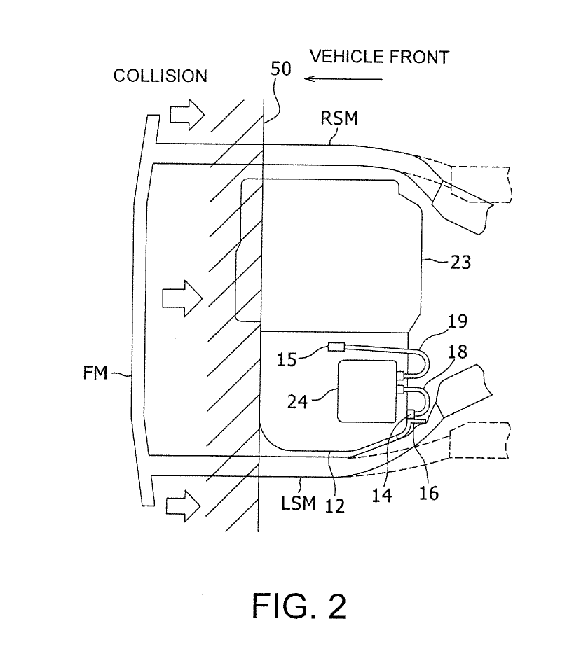

The connector 14 is mounted by the connector plate 22 being screwed on the rear surface 12a of the motor case 12. One end of the power cable 18 is connected to the connector body 20 and is connected to the motor MG2 via a bus bar or the like in the motor case 12. On the other hand, the other end of the power cable 18 is connected to an inverter 24 (refer to FIG. 2) mounted on the motor case 12. In the present embodiment, the connector body 20 has a function to maintain, for example, 3 power cables 18 in a state of being insulated from each other. The connector body 20 has an ellipse shape or a track shape and protrudes from the connector plate 22.

The protection member 16 is a member for preventing contact of a side member LSM on a left side of the vehicle (refer to FIG. 2), which is positioned near the connector 14, with the connector 14 due to deformation during a vehicle collision. The protection member 16 is fixed on the rear surface 12a of the motor case 12 by a plurality of (in the present embodiment, two) bolts 17. A detailed structure of the protection member 16 will be described later.

FIG. 2 is a diagram showing a deformation state of the vehicle equipped with the connector protection structure 10, viewed from above the vehicle. FIG. 2 shows a state in which a barrier 50 (such as a colliding object or a front-placed member within an engine compartment) enters from the front of the vehicle, the front portion of the vehicle is crushed, and a folding deformation occurs in the side member SM. As the folding of the side member SM is significantly deformed in the inner side of the vehicle and deformed covering the protection member 16, it is necessary, in order to protect the connector 14, to handle a wrapping-around deformation of the side member SM.

Next, a placement of equipments in an engine compartment of the vehicle will be described. The vehicle comprises a front member FM provided in front in the engine compartment and extending in a vehicle width direction, and two right and left side members RSM and LSM connected to both ends of the front member FM and extending toward the rear of the vehicle. In a space formed between the side members RSM and LSM, an engine 23, and the motor case 12 mounted on the engine 23 are placed, and the inverter 24 is mounted on the motor case 12.

The motor case 12 has two connectors 14 and 15, that is, the connector 14 for the motor MG2, placed at the rear of the vehicle, and the connector 15 for the generator MG1, placed at an upper part of the motor case 12. These connectors 14 and 15 are connected to the inverter 24 by power cables 18 and 19.

As shown in FIG. 2, during collision of the vehicle in the front, there is a case where the left side member LSM of the vehicle positioned near the connector 14 folds to the inner side, and crushes the connector 14. In consideration of this, a placement may be considered in which the connector 14 is placed near the center of the vehicle, but, due to a restriction on the equipping of the motor generator MG2, the connector 14 cannot be placed near the center of the vehicle, and is placed near the left side of the vehicle.

With the above-described placement, the protection member 16 is mounted on the motor case 12 on the rear side of the vehicle and also on the side of the vehicle, and protects the connector 14 from the folding deformation of the side members RSM and LSM. The side members RSM and LSM function as components for increasing strength and rigidity of the front section of the vehicle body, and at the same time, function as mounting bases for mounting various devices. For this purpose, various technologies related to absorption of impact for securing safety of the passengers in the driver seat and the passenger seat have been introduced.

In the present embodiment, a case is described in which the connector 14 is placed near the left side of the vehicle, but the present invention is not limited to such a configuration, and may alternatively be applied to a case where the motor case 12 is equipped near the right side of the vehicle with respect to the engine 23, and the connector 14 is also placed on the motor case 12 near the right side of the vehicle.

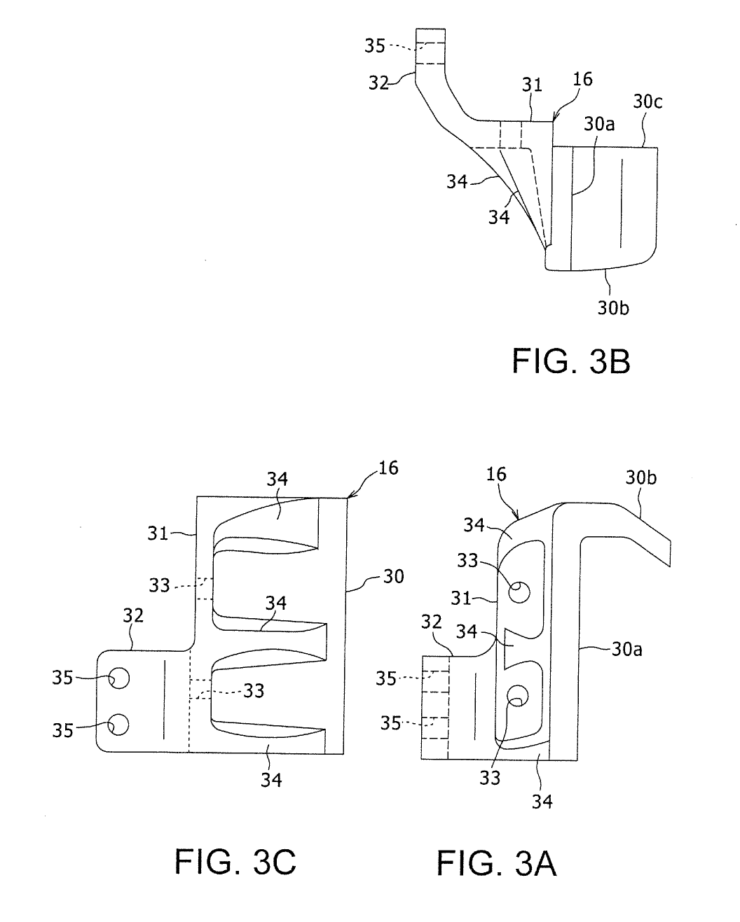

FIG. 3 shows three-way diagrams ((a) front view, (b) upper view, and (c) side view) showing the protection member 16 in the present embodiment. With reference to FIG. 1 and FIG. 3, the protection member 16 is provided between the side member LSM on the left side of the vehicle positioned near the connector 14 and the connector 14, and has a function to protect the connector 14 so that the side member LSM does not contact the connector 14 when the side member LSM is deformed in vehicle collision. The protection member 16 has a protection section 30, a fixing section 31, and a support section 32 in an integrated manner, and is formed, for example, through hot forging of a steel member. However, the protection member 16 is not limited to such a configuration, and may be formed by bending and machining or welding a steel plate, or by a die-cast component made of iron, so long as the structure can withstand a collision load of the side member SM to the connector 14.

The protection section 30 of the protection member 16 is a wall section provided covering at least a part of the periphery of the connector 14, more specifically, the side and the upper parts thereof. The protection section 30 is provided in a projected arrangement on the rear side of the vehicle approximately perpendicular to a rear surface 12a of the motor case 12. The protection section 30 is also formed having a height at least exceeding a protruding height of the connector body 20 from the rear surface of the motor case 12. By forming the protection section 30 to such a height, it becomes possible to reliably prevent contact of the side member LSM to the connector 14 and the connection end of the power cable 18.

The protection section 30 comprises, in an integrated manner, a side protection section 30a provided covering a side of the connector 14 and an upper protection section 30b provided covering a region above the connector 14. A front side surface 30c of the upper protection section 30b and the connector plate 22 of the connector 14 or the rear surface 12a of the motor case 12 contact each other, or a small gap is maintained therebetween. During collision, the front side surface 30c of the upper protection section 30b contacts the connector plate 22 or the rear surface 12a of the motor case 12, so that the collision load of the collision is also applied on the upper protection section 30b, the detachment of the protection section 30 is prevented, and tilting of the protection section 30 to the side of the connector 14 tends to not occur. In addition, an area of an end surface of the protection section 30 facing the rear side of the vehicle becomes larger, so that the receiving surface of the collision load of the side member LSM is widened.

The fixing section 31 of the protection member 16 is bent in a predetermined angle with respect to the protection section 30, and integrally linked thereto. Two bolt holes 33 are formed on the fixing section 31. Bolts 17 inserted through these bolt holes 33 are screwed into female screw holes formed on the rear surface 12a of the motor case 12 so that the fixing section 31 is fixed on the rear surface 12a of the motor case 12 in a seated state.

Three ribs 34 having an approximate triangular shape are integrally provided between the fixing section 31 and the protection section 30. With this configuration, the protection section 30 is reinforced to increase the strength with respect to the collision load to be described later.

The support section 32 of the protection member 16 is bent in a predetermined angle from the protection section 30 and is integrally linked thereto. On the support section 32, a plurality of (in the present embodiment, two) through holes 35 are formed. As shown in FIG. 1, these through holes 35 form a fitting structure to support the protection member 16 on the side surface 12b of the motor case 12 by the studs 13 provided in a projected arrangement on the side surface 12b of the motor case 12 being penetrated and inserted through the through holes 35.

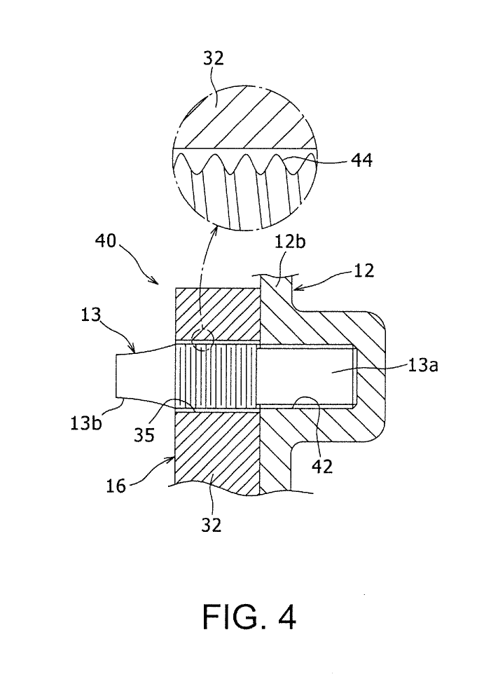

FIG. 4 is an enlarged view showing a fitting structure 40 between the stud 13 and the through hole 35 described above. In the stud 13 of the fitting structure 40, a male screw 13a is formed on an outer circumferential surface on the side of one end, and the stud 13 is fixed on the motor case 12 by the male screw 13a being tightened in a female screw hole 42 formed on the side surface 12b of the motor case 12.

On an outer circumferential surface of the other end protruding from the side surface 12b of the motor case 12, a hook portion 44 is formed that inhibits deviation of the stud 13 in the axial direction within the through hole 35 of the support section 32 of the protection member 16 when the collision load is input from the side member LSM to the protection member 16. In the present embodiment, the hook portion 44 of the stud 13 is formed as a male screw thread.

A tip of the other end 13b of the stud 13 has a shape tapered and narrowed toward the tip from the portion where the male screw thread is formed. With such a configuration, there is an advantage that, when the protection member 16 is assembled onto the motor case 12, it becomes easier to insert through the through hole 35 of the support section 32, and the assembly capability of the protection member 16 is improved. The hook portion 44 is not limited to a male screw thread, and may be of any shape so long as the hook portion 44 is a projected section having a shape that engages and hooks onto the inner circumferential surface of the through hole 35 of the protection member 16.

The through holes 35 of the support section 32 of the protection member 16 of the above-described fitting structure 40 are formed in a size that allows a slight gap to be formed for a portion in which the male screw thread 44 of the stud 13 is formed. More specifically, the above-described gap is preferably set to an extent that the protection member 16 contacts the male screw thread 44 of the stud 13 when the protection member 16 is tilted by a predetermined angle (for example, 1 degree) from the mounted state of the protection member 16 when the side member LSM contacts the protection member 16 and a collision load is input during vehicle collision, as will be described later. By setting the gap in this manner, it becomes possible to insert the stud 13 into the through hole 35 without resistance, and to provisionally place the protection member 16 with respect to the motor case 12 at the same time, which allows the assembly capability of the protection member 16 to be improved.

In the fitting structure 40 of the present embodiment, two pairs of the stud 13 and the through hole 35 are provided. The present invention, however, is not limited to such a configuration, and the number of pairs of the stud 13 and the through hole 35 may be three or more, or may be one. When a plurality of pairs of the studs and the through holes are employed, the collision load which is input to the protection member 16 is distributed and received by the plurality of studs 13, resulting in consequent reduction of stress applied on the motor case 12 and inhibition of damage to the motor case 12. On the other hand, when a fitting structure with one pair of stud and through hole is employed, there is an advantage that the number of components and cost can be reduced, and, because the protection member 16 may be provisionally placed in a state where the fixing section 31 of the protection member 16 is in contact with the rear surface 12a of the motor case 12, the assembly capability of the protection member 16 is not made worse.

Next, assembly of the protection member 16 onto the motor case 12 will be described. First, the stud 13 provided in a projected arrangement on the side surface 12b of the motor case 12 is inserted through the through hole 35 of the support section 32 of the protection member 16, to provisionally place the support section 32 in a state where the support section 32 is in contact with the side surface 12b of the motor case 12. In the provisional placement state, the fixing section 31 of the protection member 16 contacts the rear surface 12a of the motor case 12, and the bolt hole 33 formed on the fixing section 31 is made to coincide with the female screw hole on the motor case 12. The bolt 17 is then inserted into the bolt hole 33 and tightened. With such a configuration, the fixing section 31 is fixed on the rear surface 12a of the motor case 12 in a seated state without a gap, and the protection member 16 is mounted on the motor case 12.

As described, in the present embodiment, after the stud 13 is inserted through the through hole 35 to provisionally place the support section 32 of the protection member 16 on the side surface 12b of the motor case 12, the fixing section 31 of the protection member 16 is tightened with the bolt 17 on the rear surface 12a of the motor case 12 in a reliably seated state, and the protection member 16 can be fixed on the motor case 12. Therefore, the assembly capability of the protection member 16 onto the motor case 12 can be improved.

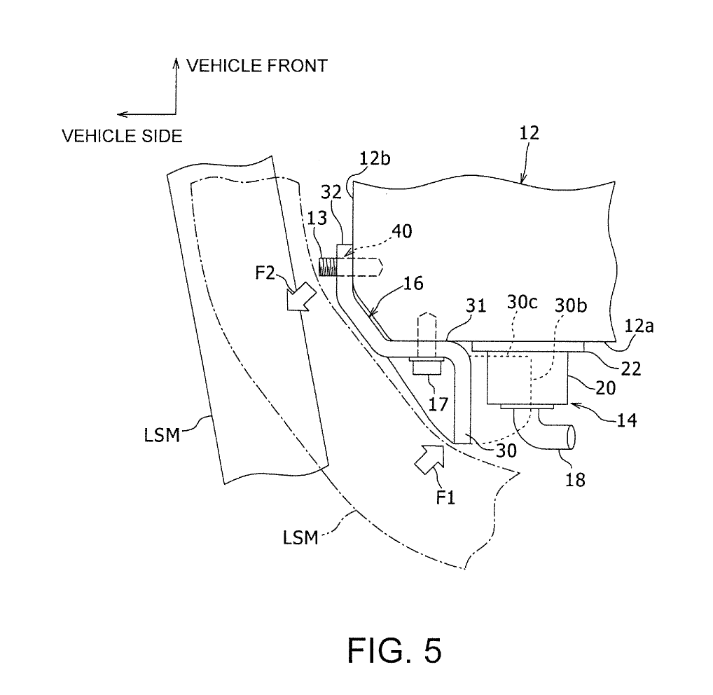

FIG. 5 is an explanatory diagram for explaining a contact state of the protection member 16 and the side member LSM in the present embodiment. In FIG. 5, in order to facilitate viewing of the connector 14, the upper protection section 30b of the protection section 30 of the protection member 16 is not shown.

As described above with reference to FIG. 2, when the side member LSM is deformed in a wrapping manner due to collision in the front side of the vehicle, the side member LSM is deformed as shown by a dot-and-chain line in FIG. 5, and contacts the protection section 30 of the protection member 16. With this process, a collision load F1 is input to the protection member 16 from a diagonal rear side of the vehicle. The protection member 16 is designed to have a sufficient strength to withstand such a collision load F1, and thus, the protection section 30 does not fall onto the side of the connector 14. Therefore, the connector 14 of the motor case 12 and the power cable 18 can be reliably protected during collision of the vehicle in the front side.

In addition, in the present embodiment, when the collision load F1 is input to the protection member 16, a collision load F2 is caused as a reaction thereof, on the fitting structure 40 made of the through hole 35 of the support section 32 of the protection member 16 and the stud 13 of the motor case 12, toward the diagonal rear direction of the vehicle. In this case, because there is a slight gap, the support section 32 of the protection member 16 can be deviated with respect to the stud 13. As a result, a part of the collision load F2 can be released. Therefore, the collision load acting on the side surface 12b of the motor case 12 through the stud 13 can be reduced, and the damage to the motor case 12 can be inhibited. At the same time, a collision load F3 acts on the upper protection section 30b. Because the front side surface 30c of the upper protection section 30b contacts the connector plate 22 or the rear surface 12a of the motor case 12, falling of the protection member 16 is inhibited, and thereby the collision load acting on the side surface 12b of the motor case 12 can be reduced.

In addition, when the collision load F2 acts on the fitting structure 40, the male screw thread 44 formed on the stud 13 engages the inner circumferential surface of the through hole 35 formed in the support section 32 of the protection member 16, so that a significant deviation of the support section 32 with respect to the stud 13 is prevented. Therefore, the collision load F1 which is input to the protection member 16 can be received not only by the protection section 30 to which the side member LSM contacts and the rear surface 12a of the motor case 12, but also by the side surface 12b of the motor case 12 facing a different direction and the stud 13. As a result, the protection member 16 is not detached from the motor case 12, and the connector 14 can be more reliably protected.

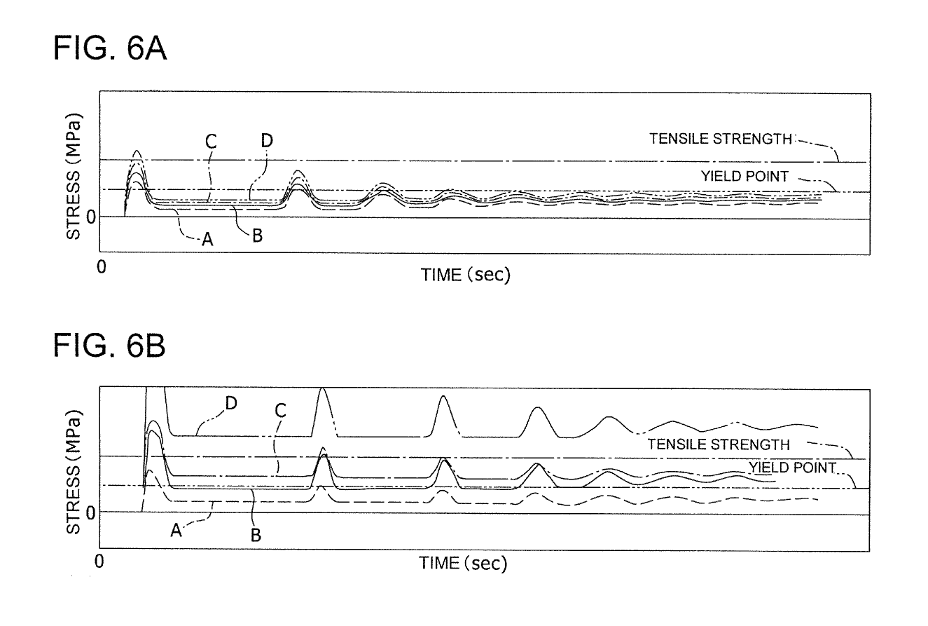

FIG. 6 is a graph showing a stress generation state of the motor case in FIG. 6A the present embodiment and in FIG. 6B a Comparative Example. As in FIG. 6B the Comparative Example, a structure was used in which the support section 32 of the protection member 16 was fixed by bolts fastened in the female screw holes for the studs formed on the side surface 12b of the motor case 12. In other words, the Comparative Example corresponds to the structure of FIG. 5 of JP 2013-66327 A. Strain gauges were placed on 4 locations A, B, C, and D near the female screw holes 42 for the studs on the side surface 12b of the motor case 12, and an experiment was performed to measure stress generated on the side surface 12b of the motor case 12 during collision at the front side of the vehicle.

In FIGS. 6A and 6B, the stresses in strain measurement locations A, B, C, and D are shown on the graphs showing time on the horizontal axis and the stress on the vertical axis. In these graphs, a tensile strength on the side surface 12b of the motor case 12 is shown by a dot-and-chain straight line and a yield point of the side surface 12b is shown by a two-dots-and-chain straight line.

As shown in FIG. 6A, in the vehicle having the connector protection structure 10 of the present embodiment, of the 4 locations, the stress at the measurement location D where the stress is maximum and slightly exceeds the tensile strength for only an instantaneous moment. On the other hand, in the vehicle equipped with the connector protection structure of the Comparative Example, the stress at the measurement location D significantly exceeds the tensile strength for a relatively long period of time after collision, and cracking was caused on the side surface 12b of the motor case 12. Based on this, it was confirmed that, according to the present embodiment, the collision load transmitted to the motor case by the collision load caused by the contact of the deformed side member LSM on the protection member 16 is reduced, and the damage to the motor case 12 is effectively inhibited.

The connector protection structure of the motor according to the present invention is not limited to the above-described embodiment and alternative embodiments thereof, and various changes and improvements may be made within the description in the claims and equivalent structures thereof.

For example, in the above description, a structure is described in which the male screw thread 44 is formed as the hook portion on the outer circumferential surface of the stud 13, but the present invention is not limited to such a configuration, and in place of or in addition to the male screw thread 44 of the stud 13, a female screw groove may be formed on the inner circumferential surface of the through hole 35 of the protection member 16. With such a hook structure also, detachment of the support section 32 of the protection member 16 from the motor case 12 can be effectively prevented while allowing a slight deviation during the collision and consequently releasing the collision load.

In addition, in the above description, a structure is described in which the protection section 30 of the protection member 16 comprises the side protection section 30a and the upper protection section 30b, but the present invention is not limited to such a configuration, and alternatively, the protection section 30 may be formed with only the side protection section 30a.

Moreover, in the above description, the fitting structure 40 including the stud 13 and the fitting hole 35 is provided on the side surface 12b of the motor case 12, but the present invention is not limited to such a structure, and the fitting structure 40 may alternatively or additionally be provided on the upper surface 12c of the motor case 12.

What is claimed is:

1. A connector protection structure of a motor, comprising:
a motor case that houses a motor;
a connector that is placed on an outer surface of the motor case in an exposed manner and that is configured to supply electric power to the motor; and
a protection member that is provided between the connector and a side member of a vehicle near the connector, and that is fixed on the motor case, wherein
the protection member comprises:
a protection section that is provided in a projected arrangement around the connector;
a fixing section that is linked to the protection section and that is fixed by a bolt on a first side surface of the motor case; and
a support section that is linked to the fixing section, that has a through hole through which a stud, provided in a projected arrangement on a second side surface of the motor case in an orientation different from the first side surface, penetrates, and that is supported on the second side surface by the stud.

2. The connector protection structure of motor according to claim 1, wherein
a hook portion that inhibits deviation of the stud in an axial direction in the through hole due to an input of a collision load is formed on at least one of an outer circumferential surface of the stud and an inner circumferential surface of the through hole.

3. The connector protection structure of motor according to claim 2, wherein
the hook portion is a male screw thread formed on the outer circumferential surface of the stud or a female screw groove formed on the inner circumferential surface of the through hole.

4. The connector protection structure of motor according to claim 1, wherein
the protection section of the protection member includes, in an integrated manner, a side protection section provided covering a side portion of the connector and an upper protection section provided covering an upper portion of the connector.

5. The connector protection structure of motor according to claim 2, wherein
the protection section of the protection member includes, in an integrated manner, a side protection section provided covering a side portion of the connector and an upper protection section provided covering an upper portion of the connector.

6. The connector protection structure of motor according to claim 3, wherein
the protection section of the protection member includes, in an integrated manner, a side protection section provided covering a side portion of the connector and an upper protection section provided covering an upper portion of the connector.
